(19) United States
(12) Patent Application Publication
(10) Pub. No.: US 2023/0256646 A1
(43) Pub. Date: Aug. 17, 2023

(54) Production Method For Modified Lignocellulose Materials

(71) Applicant: Georg-August-Universität Göttingen Stiftung Öffentlichen Rechts, Göttingen (DE)

(72) Inventor: Holger Militz, Bovenden (DE)

(73) Assignee: Georg-August-Universität Göttingen Stiftung Öffentlichen Rechts, Göttingen (DE)

(21) Appl. No.: 18/024,751

(22) PCT Filed: Sep. 8, 2021
(86) PCT No.: PCT/EP2021/074636

§ 371 Date: Mar. 4, 2023

(30) Foreign Application Priority Data
Sep. 9, 2020 (EP) 20195348.6

(51) Int. Cl. B27K 3/50; B27K 3/02; B27K 3/15; B27K 5/00

(52) U.S. Cl. CPC B27K 3/50; B27K 3/0292; B27K 3/15; B27K 5/001

(57) ABSTRACT

Production method for modified lignocellulose materials. The present invention relates to a production method for modified lignocellulose materials, comprising the impregnation of a lignocellulose material, especially wood, with a solution of an acid and an alcohol as well as treatment of the material with superheated steam at elevated temperatures.

The present invention relates to a process for the manufacture of modified lignocellulose materials. The invention further relates to the lignocellulose materials which can be obtained by this process.

Lignocellulose materials, in particular wood but also other lignocellulose materials such as bamboo, natural fibers and the like, are of interest as building and construction materials for many applications. One disadvantage is that the natural durability of these materials is disadvantageously affected both by the effect of moisture and by changes in the moisture content in the surrounding atmosphere. The reason for this is the property of lignocellulose materials, on contact with water or in a moist atmosphere, of taking up water and of releasing it again in a dry atmosphere. The swelling or shrinking which accompanies this and the lack of dimensional stability of the materials associated with this is not only undesirable for many applications but can in the extreme case also result in destruction of the material by cracking.

Moreover, these materials in the moist state are attacked by wood-decomposing or wood-discoloring microorganisms or insects, which in many cases makes necessary the treatment of these materials with fungicides/biocides. Apart from the cost aspect, such a finishing is also disadvantageous from ecological considerations.

To improve the durability and dimensional stability, wood and comparable lignocellulose-based materials are frequently coated or hydrophobized, e.g. by treatment with alkyd- or acrylic coatings or wax-comprising impregnating agents. Through this, penetration of water into the pores of the material is made more difficult, the dimensional stability of these materials is improved and the danger of infection by fungi or bacteria is reduced.

There is a constant need for novel production methods for modifying lignocellulose materials and thus it is an object to provide such methods and the lignocellulose materials which are obtained by these processes.

This object is solved by a process according to claim 1. Accordingly, a process for the preparation of a modified lignocellulose material is provided, comprising the steps of
a) impregnating the lignocellulose material with an aqueous impregnation composition comprising i) an organic compound having more than one hydroxy group and ii) an organic carboxylic acid having more than one carboxylic group; and
b) treating the impregnated lignocellulose material at an elevated temperature,
   whereby step b) comprises the treatment of the impregnated lignocellulose material with superheated steam, where the superheated steam has a temperature of ≥100° C.

Surprisingly it has been found that by using this method, for many applications one or more of the following advantages can be found
The impregnation composition is nitrogen-free and also releases no formaldehyde, still a very good performance of the lignocellulose material can be observed, especially in view of resistance against wood-decaying organisms, especially fungi, an increased dimension stability and reduced absorption of water
The process can be installed on an industrial basis and also for larger objects
In many applications, a colorization of the lignocellulosic material can be found, thus additional staining processes etc. can be saved
The emission of undesired by-products, especially formaldehyde, is greatly reduced or even abolished.

The term, “organic compound having more than one hydroxy group”—in the following for sake of brevity and readability also to be referred as compound i)—comprises and/or includes an organic compound having at least two carbon atoms and more than one hydroxy moiety within the compound. Preferably the organic compound having more than one hydroxy group comprises at least three carbon atoms and at least three hydroxy groups.

Preferred organic compound having more than one hydroxy groups are carbohydrates and/or sugar alcohols. Especially preferred are sorbitol, glucose, glycerol, dextrines, xylitol, saccharose, fructose, mannitol, erythritol, lactit, isomalt, maltitol, hydrated starch hydrolysate (HSH), threitole, adonitole, arabitole, galaktite and inosite or mixtures thereof, with sorbitol and/or erythritol being especially preferred.

The term, “organic carboxylic acid having more than one carboxylic group”—in the following for sake of brevity and readability also to be referred as compound ii)—comprises and/or includes an organic carboxylic acid having at least two carboxylic acid moieties. Especially preferred are organic carboxylic acid having more than one carboxylic groups with two or three carbonic acid moieties.

Preferred organic carboxylic acid having more than one carboxylic group are selected out of the group comprising oxalic acid, malonic acid, succinic acid, glutaric acid, adipic acid, fumaric acid, citric acid, maleic acid, isocitric acid, aconitic acid, malic acid, oxalosuccinic acid, trimesic acid, trimellitic acid, hemimellitic acid or mixtures thereof. Especially preferred is citric acid.

According to a preferred embodiment of the present invention the ratio of compound i) to compound ii) in mol/mol—or, if there is more than one compound i) and/or compound ii), the ratio of the sum of the compounds i) to the compounds ii)—is ≥0.5 to ≤10:1, preferred≥1:1.5 to ≤5:1 and most preferred≥1 to ≤3:1.

According to an alternative preferred embodiment of the present invention the ratio of compound i) to compound ii) in mol/mol—or, if there is more than one compound i) and/or compound ii), the ratio of the sum of the compounds i) to the compounds ii)—is ≥1:10 to ≤2, preferred≥1:5 to ≤1.5 and most preferred≥1:3 to ≤1.

According to a preferred embodiment of the present invention the ratio of compound i) to compound ii) in mol/mol—or, if there is more than one compound i) and/or compound ii), the ratio of the sum of the compounds i) to the compounds ii)—are chosen so that X is ≥0.05 to ≤1, preferred≥0.06 to ≤0.5 and most preferred≥0.1 to ≤0.4, whereby X is calculated as follows:
X=[X1/X2]/[X3/X4], with
X1=the molar amount of compound i)
X2=the number of hydroxy moieties in compound i)
X3=the molar amount of compound ii)
X4=the number of carboxylic acid moieties in compound ii)

According to a preferred embodiment, the impregnation composition is nitrogen-free. This especially means and/or includes, that, besides unavoidable impurities, there is no compound present in the impregnation composition that contains nitrogen, especially no organic compound that contains nitrogen.

According to a preferred embodiment of the invention, the impregnation composition is formaldehyde-free and/or releases no formaldehyde during the inventive process or in the final lignocellulose material made according to the process. This especially means and/or includes that the composition contains no compound which will release, e.g. by degradation or hydration, formaldehyde during the manufacturing process according to the present invention.

According to one embodiment of the present invention, the impregnation composition furthermore comprises a catalyst.

Preferred catalysts are (Lewis-)acids, especially inorganic (Lewis-)acids. Especially preferred catalysts are selected from phosphoric acid, as well as sodium and/or potassium phosphates, sulfonic acids, nanoclays, zeolithes.

According to one embodiment of the present invention, the catalyst is selected from sodium hypophosphite, magnesium chloride, sulfuric acid, and hydrochloric acid, preferably sodium hypophosphite, magnesium chloride, and sulfuric acid.

The impregnation composition comprises the catalyst in an amount of ≥0.1 wt. % to ≤50 wt. %, preferred≥0.2 wt. % to ≤30 wt. %, more preferred≥0.5 wt. % to ≤20 wt. % preferred≥0.5 wt. % to ≤10 wt. % and most preferred≥0.5 wt. % to ≤8 wt. %.

The ratio of the catalyst to the (combined) compounds i) and ii) (in wt/wt) is preferably ≥0.1 to ≤50 preferred≥5% to ≤30% and most preferred≥10% to ≤20%.

According to the invention, the process comprises the step of impregnating the lignocellulose material with an aqueous impregnation composition.

The impregnation can be carried out in a way conventional per se, e.g. by immersion, by application of vacuum, if appropriate in combination with increased pressure, or by conventional application methods, such as spreading, spraying and the like.

The impregnation method used in each case naturally depends on the dimensions of the material to be impregnated. Lignocellulose materials having small dimensions, such as shavings or strands, and also thin veneers, i.e. materials with a high ratio of surface area to volume, can be impregnated cheaply, e.g. by immersion or spraying, whereas lignocellulose materials having larger dimensions, in particular materials having a smallest extent of more than 5 mm, e.g. solid wood, moldings made of solid wood or wood materials, are impregnated by application of pressure or vacuum, in particular by combined application of pressure and vacuum. The impregnation is advantageously carried out at a temperature of less than 50° C., e.g. in the range from 15 to 50° C.

The conditions of the impregnation are generally chosen so that the amount of the sum of compound i) and ii)—in the following also to be referred to as “curable constituents”—from the aqueous composition taken up corresponds to the desired charge. Generally, the amount of curable constituents taken up is at least 5% by weight, based on the dry weight of the untreated material. The amount of curable constituents taken up can be up to 100% by weight, based on the dry weight of the untreated materials, and frequently ranges from 5 to 60% by weight, preferably ranges from 10 to 50% by weight, based on the dry weight of the untreated material used.

According to a preferred embodiment of the present invention, for immersion, the lignocellulose material, if appropriate after pre-drying, is immersed in a container comprising the aqueous composition. The immersion is preferably carried out over a period of time from a few seconds to 24 h, in particular 1 min to 6 h. The temperatures usually range from 15° C. to 50° C. Doing this, the lignocellulose material takes up the aqueous composition, it being possible for the amount of the non-aqueous constituents (i.e., curable constituents) taken up by the wood material to be controlled by the concentration of these constituents in the aqueous composition, by the temperature and by the duration of treatment.

The amount of constituents actually taken up can be determined and controlled by a person skilled in the art in a simple way via the increase in weight of the impregnated material and the concentration of the constituents in the aqueous composition.

Veneers can, for example, be prepressed using press rolls, i.e. calenders, which are present in the aqueous impregnation composition. The vacuum occurring in the wood on relaxation then results in an accelerated uptake of aqueous impregnation composition.

The impregnation is advantageously carried out by combined application of reduced and increased pressure. For this, the lignocellulose material, which generally exhibits a moisture content in the range from 1% to 100%, is first brought into contact with the aqueous composition, e.g. by immersion in the aqueous composition, under a reduced pressure which is frequently in the range from 10 to 500, preferably 700 mbar and in particular in the range from 40 to 100 mbar. The duration is usually in the range from 1 min to 5 h., preferably up to 10 h.

This is followed by a phase at increased pressure, e.g. in the range from 2 to 20 bar, in particular from 4 to 15 bar and especially from 5 to 12 bar. The duration of this phase is usually in the range from 1 min to 12 h, preferably up to 24 h. The temperatures are usually in the range from 10 to 50° C., preferably 15 to 40° C. Doing this, the lignocellulose material takes up the aqueous composition, it being possible for the amount of the non-aqueous constituents (i.e., curable constituents) taken up by the wood material to be controlled by the concentration of these constituents in the aqueous composition, by the pressure, by the temperature and by the duration of treatment. The amount actually taken up can also here be calculated via the increase in weight of the lignocellulose material.

Furthermore, the impregnation can be carried out by conventional methods for applying liquids to surfaces, e.g. by spraying or rolling or spreading. With regard to this, use is advantageously made of a material with a moisture content of not more than 50%, in particular not more than 30%, e.g. in the range from 12% to 30%. The application is usually carried out at temperatures in the range from 15 to 50° C. The spraying can be carried out in the usual way in all devices suitable for the spraying of flat or finely divided bodies, e.g. using nozzle arrangements and the like. For spreading or rolling, the desired amount of aqueous composition is applied to the flat material with rolls or brushes.

Following step a) according to a preferred embodiment of the present invention, immediately step b) may follow, whereby “immediately” in this context especially means and/or includes that there is no deliberate delay in the process.

However, according an alternative preferred embodiment, between step a) and step b) there may be a storing break and/or a first drying step, depending on the actual application.

According to a preferred embodiment, no pre-drying is performed on the impregnated lignocellulose material. Particularly, no drying may be performed between step a) and step b).

The treatment in step b) of the impregnated lignocellulose material obtained in step a) comprises, according to the invention, treatment with superheated steam, also referred to subsequently as dry steam. These terms are understood to mean steam having a temperature greater, preferably ≥5 K and in particular ≥10 K greater, than the saturation temperature of the steam at the pressure present each time.

According to a preferred embodiment of the present invention, the treatment step occurs at a set temperature T_{A} which is kept essentially constant throughout the treatment. The term “essentially constant” especially means and or includes that the temperature during the treatment does not deviate from the set temperature T_{A} by more than 5° C., more preferred 3° C.

The set temperature T_{A} is preferably ≥110° C. to ≤180° C., preferred≥120° C. to ≤170° C., more preferred≥125° C. to ≤160° C., yet more preferred≥130° C. to ≤150° C. and most preferred≥135° C. to ≤140° C.

Alternatively, the set temperature T_{A} is preferably ≥100° C. to ≤140° C., preferred≥105° C. to ≤130° C., more preferred≥110° C. to ≤120° C.

According to one embodiment of the present invention, the impregnation composition furthermore comprises a catalyst and the set temperature T_{A} is preferably ≥100° C. to ≤140° C., preferred≥105° C. to ≤130° C., more preferred≥110° C. to ≤120° C.

The superheated steam can be obtained through the use of suitable devices, including (external) steam generators, heating elements, heat exchangers, fans and/or treatment chambers. Especially when a treatment chamber is used, it can be advantageous to provide for a unit for the posttreatment of the steam emerging from the treatment chamber in order to reduce loading with organic materials.

Superheated steam can be generated in steam generators with heat exchangers known for this purpose. In addition, wet steam, i.e. saturated steam can be introduced into the treatment chamber and the wet steam can be superheated, i.e. converted to superheated steam, using heat exchangers installed in the treatment chamber. On integrated chemical sites with crude oil refining, superheated steam is available from other processes, such as the FCC process, methanol manufacture, and the like.

In a preferred embodiment, the superheated steam is generated in situ inside the treatment chamber. For this, the lignocellulose material is first charged to the chamber and subsequently, during a heating-up phase, the chamber is filled with non-superheated steam (wet steam). For this, as the chamber is being heated up, the relative air humidity is kept constant at approximately 100%. After reaching a temperature of approximately 100° C., the steam is further heated by supplying additional heat energy, thus producing superheated steam.

Under these conditions, water still present in the lignocellulose material is converted to the gaseous state and, in addition to the curing/crosslinking, in most applications the moisture is simultaneously transported from the inside of the wood to the surface of the wood as a result of the pressure difference from the chamber. Consequently, the drying process can generally even be shortened in comparison with a conventional drying.

According to a preferred embodiment, no additional pressure is applied in step b).

Particularly, step b) is performed at atmospheric pressure.

According to a preferred embodiment, step b) includes a step b1)
b1) Heating the temperature up to ≥100° C. and generating a superheated stream atmosphere

According to a preferred embodiment, step b) includes a step b2) and b3), which can follow after step b1):
b2) Heating the temperature to the set temperature T_{A} with a heating rate of ≤5° C. per hour
b3) Treating the impregnated lignocellulose material at the set temperature T_{A}

It should be noted that b2) and b3) can be performed without previously performing b1). In this case it is preferred that a superheated stream atmosphere is generated once the temperature reaches and/or exceeds 100° C.

For many applications it has been shown that such a slow heating step to reach the set temperature, where subsequently the lignocellulose material is treated, is advantageous because by doing for many applications better results, especially means a more uniform distribution of the cured modifying agent, can be reached and especially tensions and cracks within the modified lignocellulose material can be reduced or mostly even avoided.

The heating rate in step b2 is preferably ≥0.05° C. to ≤4° C. per hour, more preferred≥0.1° C. to ≤3° C. per hour.

The superheated steam used for the treatment in step b) and especially in step b3) preferably exhibits a pressure in the range from ≥0.9 to ≤5 bar and will in particular not exceed a pressure of 3 bar and particularly preferably 2 bar.

According to a preferred embodiment, no additional pressure is applied in step b3).

Particularly, step b3) is performed at atmospheric pressure.

According to a preferred embodiment step b) includes a step ba)
ba) Heating the temperature up to a temperature T_{B} lower than T_{A}, whereby the difference between T_{B} and T_{A} is ≥15° C., preferably ≥20° C., more preferred≥25° C. and most preferred≥30° C.

According to a preferred embodiment, step b) includes a step bb) and bc), which can follow after step ba):
bb) Heating the temperature to the set temperature T_{A} with a heating rate of ≤5° C. per hour
bc) Treating the impregnated lignocellulose material at the set temperature T_{A}.

It should be noted that bb) and bc) can be performed without previously performing 1). In this case it is preferred that a superheated stream atmosphere is generated once the temperature reaches and/or exceeds 100° C.

It should furthermore be noted that when the set temperature T_{A} with is relatively low as a result the temperature T_{B} may be lower than 100° C. In this case it is preferred that a superheated stream atmosphere is generated while performing step bb) once the temperature reaches and/or exceeds 100° C.

For many applications it has been shown that such a slow heating step to reach the set temperature, where subsequently the lignocellulose material is treated, is advantageous because by doing for many applications better results, especially means a more uniform distribution of the cured modifying agent, can be reached and especially tensions and cracks within the modified lignocellulose material can be reduced or mostly even avoided.

The heating rate in step bb) is preferably ≥0.05° C. to ≤4° C. per hour, more preferred≥0.1° C. to ≤3° C. per hour.

The superheated steam used for the treatment in step bc) preferably exhibits a pressure in the range from ≥0.9 to ≤5 bar and will in particular not exceed a pressure of 3 bar and particularly preferably 2 bar.

According to a preferred embodiment, no additional pressure is applied in step bc).

Particularly, step bc) is performed at atmospheric pressure.

The duration of the treatment (in case of repeated treatment with superheated steam, the total duration) with superheated steam in stage b), i.e. in particular steps b3) and/or bc) preferably ranges from 1 min to 500 hours, particularly preferably from 5 min to 200 hours and most preferred 1 hr to 48 hrs, depending on the application. With veneers and finely divided lignocellulose materials, higher temperatures and shorter times may be used.

Preferably, the treatment with superheated steam is carried out for so long until the residual moisture in the lignocellulose material is not more than 10%, in particular not more than 8% and especially not more than 7%, e.g. 2 to 10%, in particular 3 to 8% and especially approximately 4 to 7%.

The residual moisture can be determined conventionally via conductivity measurements.

According to a preferred embodiment the process comprises a step c), following after step b)
c) Cooling with a cooling rate of ≤10° C. per hour at a superheated stream atmosphere

The cooling rate in step c) is preferably ≥0.1° C. to ≤5° C. per hour, more preferred≥0.5° C. to ≤2° C. per hour.

According to a preferred embodiment the process comprises a step d), following after step c)
d) Cooling the temperature to ≤100° C. with a cooling rate of ≤20° C. per hour at a humidity of ≥70% to ≤100%

The cooling rate in step d) is preferably ≥0.5° C. to ≤10° C. per hour, more preferred≥1° C. to ≤5° C. per hour. The humidity in step d) may vary over time.

The present invention furthermore relates to the use of the process according to the present invention for modifying lignocellulose material, especially wood material.

According to a preferred embodiment of the invention, the process is used for modifying wood material, preferably with a thickness in the range from ≥0,005 cm to ≤40 cm, preferably from ≥0.1 cm to ≤20 cm, more preferred from ≥1 cm to ≤5 cm.

According to a preferred embodiment of the invention, the process is used for modifying wood material, wherein the length and width of the wood material can be particularly large and is preferably only limited by the dimensions of the impregnation and drying facilities used for the process.

The present invention furthermore relates to a modified lignocellulose material, especially a modified wood material made by a process according to the present invention.

The use of modified lignocellulose materials obtained according to the process according to the invention, especially of wood materials modified in such a way, makes for many applications within the present invention possible the manufacture of objects with improved mechanical strength and improved weathering resistance, in particular reduced crack formation in those regions which are manufactured from the wood material, and reduced susceptibility of these regions to infection by wood-damaging organisms, such as wood-destroying fungi.

According to a preferred embodiment of the invention, the modified lignocellulose material comprises reaction products of i) the organic compound having more than one hydroxy group and ii) the organic carboxylic acid having more than one carboxylic group.

According to a preferred embodiment of the invention, the modified lignocellulose material comprises the reaction products of i) the organic compound having more than one hydroxy group and ii) the organic carboxylic acid having more than one carboxylic group, in an amount in the range from ≥25 wt.-% to ≤100 wt.-%, based on the total weight of the lignocellulose material, preferably in the range from ≥35 wt.-% to ≤70 wt.-%, more preferred≥40 wt.-% to ≤60 wt.-%.

According to a preferred embodiment of the invention, the modified lignocellulose material comprises the reaction products of i) the organic compound having more than one hydroxy group and ii) the organic carboxylic acid having more than one carboxylic group, after leaching for 14 days according to EN 84 in an amount in the range from ≥15 wt.-% to ≤100 wt.-%, based on the total weight of the lignocellulose material, preferably in the range from ≥30 wt.-% to ≤70 wt.-%, more preferably ≥35 wt.-% to ≤55 wt.-%.

According to a preferred embodiment of the invention, the modified lignocellulose material has a relative swelling when being water saturated, in the range from ≥0% to ≤14%, preferably in the range from ≥1% to ≤12%, more preferably in the range from ≥5% to ≤10%.

Relative swelling according to the present invention is the maximum increase in the cross-sectional area, when dry samples get water saturated.

According to a preferred embodiment of the invention, the modified lignocellulose material has an Anti-Swelling-Efficiency of ≥20% and preferably ≤100%, wherein the Anti-Swelling-Efficiency preferably is ≥30%, more preferably ≥40%, and most preferred≥50%.

Anti-Swelling-Efficiency according to the present invention is the ratio of relative swelling of a treated sample vs. the relative swelling of an untreated sample.

According to a preferred embodiment of the invention, the modified lignocellulose material has a cell wall bulking in the range from ≥1% to ≤13%, preferably in the range from ≥3% to≤10%, more preferably in the range from ≥5% to ≤9%, wherein cell wall bulking is the increase in dry dimensions of a modified lignocellulose material sample compared to the dry dimensions of the original lignocellulose material sample.

According to a preferred embodiment of the invention, the modified lignocellulose material has a cell wall bulking after leaching for 14 days according to EN 84 in the range from ≥1% to ≤10%, preferably in the range from ≥3% to ≤8%, more preferably in the range from ≥4% to ≤7%, According to a preferred embodiment of the invention, the modified lignocellulose material is formaldehyde-free.

The lignocellulose materials according to the invention and obtainable according to the process according to the invention and the objects prepared therefrom can exhibit a conventional coating, for example a varnish, a glaze or a stain, as disclosed in PCT/EP 2006/004020 (the prior German patent application 102005020387.6).

The modified wood materials of the present invention are within a wide range of applications suitable in particular for the manufacture of objects manufactured from several parts connected with each other, in which at least one part is manufactured from a modified wood material, since, because of the reduced swelling/shrinking behavior of the modified wood, the joints between the various parts are more stable and, under the influence of the weather, are subject to reduced mechanical stresses and their function can be better maintained. This is then valid in particular if the parts manufactured from the modified wood material are at least partially nonpositively locked to each other or to parts made of other materials.

Due to the reduced tendency towards swelling/shrinking of many wood materials according to the invention, it is possible furthermore to prepare weather resistant wooden objects in which several types of wood with different swelling/shrinking behavior are connected with one another through an integral joint, e.g. adhesive bonding, or a nonpositively locking joint, including a positively locking joint with nonpositively locking component, e.g. are connected with one another through a nailed or screwed joint, through dowels, through indented joints, including dovetail joints, through tenoned joints, through grooved and tongued joints, or through other mechanical joints, since an equalizing of the swelling/shrinking behavior for many applications is achieved by the treatment according to the invention.

The modified wood material of the present invention is in particular solid wood, i.e. large-size materials with sizes in the centimeter or meter range, e.g. planks, logs, round timber, beams or the like.

As already explained above, modified wood materials according to the invention are suitable in particular for the manufacture of objects comprising several parts connected with each other, in which at least one part is manufactured from a modified wood material. They are suitable in particular for the manufacture of objects in which at least two parts of the object are connected with one another in nonpositively locked fashion, at least one part of the parts connected with one another in nonpositively locked fashion being manufactured from a modified wood material.

Because of the insensitivity of many applications with regard to effects of moisture, the invention also relates in particular to the use of modified wood materials for the manufacture of objects which are subject to moisture or weathering conditions. The effect of moisture can be contact with high air humidity, e.g. if the objects are found in locations subjected to moisture, such as bathrooms, indoor swimming pools, saunas, laundries, the inside of ships, and the like, or, however, also if they are subjected to high air humidity outdoors. The contact with moisture can also be contact with liquid water or with standing moisture, e.g. by the action of rain, by contact with river or sea water, with hydraulic engineering edifices or with ships.

The objects can be manufactured in a way known per se by analogy to the manufacture of objects made of wood materials. Tue manufacture comprises typical wood processing actions, such as sawing, cutting, planing, milling, grinding, drilling, screwing, nailing, adhesive bonding, laminating and the like. Generally, the starting material for the manufacture of the objects is the wood material which has already been modified. However, it is also possible first to manufacture the object from an unmodified wood material and subsequently to subject the wooden constituents to a modification as described above. In a first embodiment of the invention, the modified wood material is used for the manufacture of flooring materials. Use is frequently made for this of veneer lumber in which the decorative surface exposed to the weather is made of a veneered laminated wood layer modified according to the invention.

An example of this is parquet flooring, including strip parquet, solid wood parquet, mosaic parquet, industrial parquet, ready-to-lay parquet, e.g. 2-layer or 3-layer ready-to-lay parquet, veneered floors and sports floors, e.g. are elastic sports floors and point-elastic sports floors, and also sprung parquet floors. Wood materials according to the invention are also suitable for the manufacture of plank parquet, terrace floorings, and the like. Wood materials according to the invention are also suitable for the manufacture of laminate, in which the wood material modified according to the invention in this connection generally forms the densified wood layer of the laminate.

An additionally preferred embodiment of the invention relates to a wooden object, in particular a flooring material, which consists of at least two pieces of wood connected with one another, in particular adhesively bonded pieces of wood, it being possible for the pieces of wood to be identical or different. A specific embodiment of the invention relates to a flooring material for use outdoors and use exposed to moisture. Conventional flooring materials for use outdoors and use exposed to moisture are typically boards, including floorboards, and planks manufactured from hardwood which are frequently still provided with a surface structuring.

These floorings are generally very expensive because of the high price of the hardwoods. The weather or moisture resistance is not always satisfactory. The wood materials according to the invention now allow the preparation of floorings with high durability even from inexpensive woods, such as pine, spruce, beech, poplar and the like. In particular, the wood materials according to the invention allow the preparation of flooring materials which exhibit a backing made from a first wood material according to the invention and a surface layer or wearing surface made from a second wood material which is connected, in particular by adhesive bonding, with the support.

A further surprising effect observed for many applications within the present invention is a gain of an even and appealing brown color of the wood. Nowadays used processes to produce a comparable color need high temperatures of approx. 200-220° C. to reach this effect.

The material of the backing is preferably a wood material according to the invention made from an inexpensive type of wood, in particular an inexpensive solid wood, for example a pinewood treated according to the invention. Preferably, the wood material of the wearing surface is likewise a wood material according to the invention, preferably a wood material according to the invention with a decorative appearance, for example beech treated according to the invention. However, the wearing surface can also consist of an untreated hardwood or a hardwood treated according to the invention, for example of hardwood of the durability categories 1 or 1, such as angelim, bangkirai, ekki, bilinga, cumaru, Douglas fir, eucalyptus, fava, garapa, ipe, iroko, itauba, jatoba, karri, limbali, massaranduba, mukulungu, okan, piquia, robinia, tali, tatajuba, torrado or teak. The wearing surface typically exhibits a strength (thickness) of at least 1 mm, e.g. 1 to 10 mm, in particular 2 to 8 mm. The wearing surface can exhibit a profiling, e.g. a grooved profile. The strength of the backing naturally depends on the use desired and on the strength necessary for this. It typically ranges from 5 to 100 mm, in particular from 10 to 50 mm. The floorings can have the forms of boards, panelboards, floorboards, planks or gratings. The floorings can exhibit means for connecting the individual elements of the flooring, for example grooved and tongued joints, click joints and the like.

Such floorings are typically prepared by adhesively bonding the backing to the wearing surface analogously to known processes for the adhesive bonding of wood layers, for example analogously to processes for the preparation of laminated wood or for the preparation of floorings for use indoors, which exhibit a backing and a wearing surface arranged thereon. In particular, the preparation can be carried out analogously to the process described in PCT/EP2006/001980, wood materials treated according to the invention being adhesively bonded with one another in a different fashion from the process described therein.

In an additional embodiment of the invention, the modified wood material is used for the manufacture of doors and doorframes, for example for interior doors but also for front doors. The modified wood material can be used both for the door leaf itself and for parts of the door leaf, e.g. in the form of solid wood boards or wood-base material boards for the interior construction of the door leaf or in the form of a veneer for the decorative layer on the door leaf.

In an additional embodiment of the invention, the modified wood material is used for the manufacture of windows, e.g. of window frames and/or sides of windows. The window frames and sides of windows can be manufactured from the same wood but also from different types of wood. It is likewise possible to manufacture the frame from a material other than wood and to manufacture only the sides of windows from a wood material modified according to the invention.

The wood materials modified according to the invention can also be used for the manufacture of windowsills.

In an additional embodiment of the invention, the modified wood material is used for the manufacture of furniture, in particular of that furniture or those furniture parts, which are typically manufactured from wood or wood materials.

These include closets or parts of closets, such as the body, the doors or the floors, shelves, bedsteads, slatted frames, sofa frames, chairs, tables or parts of these items of furniture, such as table bases, table tops, worktops, in particular kitchen worktops, bathroom furniture, and the like. The wood materials modified according to the invention are suitable in particular for furniture which is subjected to a greater extent to moisture or the weather, e.g. for the manufacture of kitchen furniture or bathroom furniture or for the manufacture of garden furniture, park benches, stadium seats, and the like.

In an additional embodiment of the invention, the modified wood material is used for the manufacture of objects for hydraulic engineering, e.g. for bank reinforcements, hydraulic engineering structures, such as locks, in particular lock gates, waterwheels, platforms, pontoons, landing stages and other constructions in and on water.

In an additional embodiment of the invention, the modified wood material is used for the construction of buildings or parts of buildings. This includes, in addition to the construction of windows already mentioned, in particular the use of modified wood materials in the form of construction timber for the construction of wooden houses, for framework construction, for the construction of roof constructions, for the construction of buildings of post and beam construction, for the construction of bridges, viewing platforms or carports, and for parts of buildings, such as patios, balconies, balcony railings, donner windows, and the like. This includes in addition the use of modified wood materials for the construction of staircases, including steps, e.g. wooden steps in metal staircase constructions but also for staircases and banisters manufactured completely from wood materials.

In an additional embodiment of the invention, the modified wood material is used for facade construction. In this connection, the modified wood material can both be a constituent of the facade subconstruction and form the visible part of the facade, e.g. in the form of facade panels made of the modified wood material, facade boards made of modified wood, shingles made of modified wood, and the like.

In an additional embodiment of the invention, the modified wood material is used for the manufacture of wall components and ceiling components, for example panels, grooved and tongued boards, paneled wood ceilings, but also ceiling suspensions, movable walls or wall components in post and beam construction, ceiling linings and wall linings.

Wood-based materials based on finely divided materials in the form of boards are suitable in particular for this; for example, OSB boards, particle boards, OSL boards, PSL boards, insulating boards and medium-density (MDF) and high-density (HDF) fiber boards, and the like, and also veneer lumber, such as veneered fiber boards, veneered block boards, veneered particle boards, including veneered OSL and PSL boards, plywood, glued wood, laminated wood or veneered laminated wood (e.g. LVL, Kerto laminated wood), are suitable.

In an additional embodiment of the invention, the modified wood material is used for garden construction, for example for the manufacture of fences, palisades, sight screen components, summer houses, pergolas, aviaries, and the like.

In an additional embodiment of the invention, the modified wood material is used for the manufacture of items of play equipment for the outdoors, for example for climbing frames, swings, in particular swing supporting frameworks and swing seats, play areas with apparatuses for climbing, swinging and/or sliding, for supporting frameworks of ropeways, and the like.

In an additional embodiment of the invention, the modified wood material is used for the manufacture of household articles, for example for knife blocks, breadboxes, wooden bowls, bathroom equipment, such as bath tubs, brushes, and the like, furthermore for cutting boards, cooking utensils, such as cooking spoons, turners, rolling pins, salad servers, noodle forks, and the like.

In an additional embodiment of the invention, the modified wood material is used for the construction of boats, both for the construction of hulls, e.g. for the planking, for ribs and keel, for engine bearer, for standing rigging, such as masts, spars, and for superstructures, deck planking, and other external fixtures, such as gratings, cleats, ship's wheel, control panels, hand rails and the like, and for the interior fittings of ships, e.g. for cupboard fittings, bunk fittings, cabin walls and doors, cowlings, companionways, ladders, and the like.

In an additional embodiment of the invention, the modified wood material is used for the construction of saunas, for example for walls, doors, benches, oven cladding, and the like.

In an additional embodiment of the invention, the modified wood material is used in the construction of vehicles, for example for the interior trim of the passenger compartment or of the luggage trunk, and engine compartment linings, and also insulation, for example of the engine compartment and of the luggage trunk, and also for instrument panels, wood decoration, and the like.

In an additional embodiment of the invention, the modified wood material is used for the manufacture of toys, such as building bricks, rolling balls, toy houses and toy arrangements, such as dollhouses, doll kitchens, and the like, toy cars, planes and ships, for the construction of models, such as the construction of model cars, aircraft and ships, items of play equipment, such as bats, racket frames, and the like.

In an additional embodiment of the invention, the modified wood material is used for the manufacture of musical instruments, in particular for the construction of stringed instruments, such as guitars, lutes, harps, violins, violas, cellos, double basses or parts thereof, such as bridges, resonance boxes, scrolls or pegs, furthermore for the construction of woodwind instruments, such as clarinets, oboes, bassoons, recorders, and the like, or for the construction of organs, especially for wooden pipes, and for the construction of pianos and grand pianos.

In an additional embodiment of the invention, the modified wood material is used for the manufacture of sports equipment, in particular that sports equipment which is typically manufactured from wood or wood materials, but also for sports equipment in which wood had not hitherto been used due to its lack of strength and hardness. Mention may be made, by way of examples, of bats, such as hockey and ice hockey sticks, throwing equipment, such as javelins and discuses, oars and sculls, for the construction of sports rowboats, such as sculling boats, kayaks, single sculls, Canadian canoes or gigs, and the like.

In an additional embodiment of the invention, the modified wood material is used for the manufacture of housings, including housing parts, for machines, electrical appliances, and the like.

Due to the increased strength of the modified wood materials according to many applications of the invention, it is possible in many cases to achieve a saving in weight due to reduced material expenditure. Moreover, the objects are far less susceptible to the effects of the weather and the effect of moisture. Due to the high dimensional stability resulting from the low swelling and shrinking and the production tolerances which can accordingly be achieved, the modified wood material can in some applications also be used for the manufacture of objects in which hitherto wood could not be used.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—show examples and embodiments according to the invention. Such examples and embodiments do not necessarily represent the full scope of the invention, however, and reference is made therefore to the claims and herein for interpreting the scope of the invention. It is to be understood that both the foregoing general description and the following detailed description are exemplary and explanatory only and are intended to provide further explanation of the present invention as claimed.

In the figures,

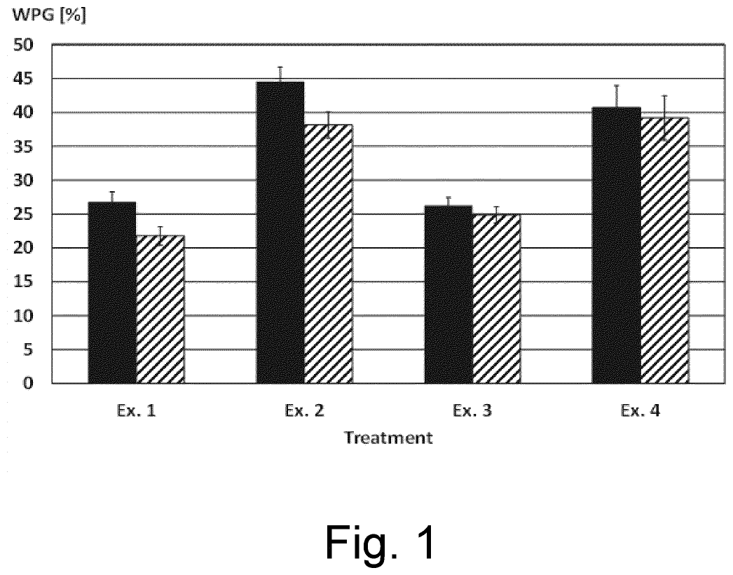

FIG. 1 is a diagram showing the weight percentage gain after treatment for a first to fourth example of the present invention,

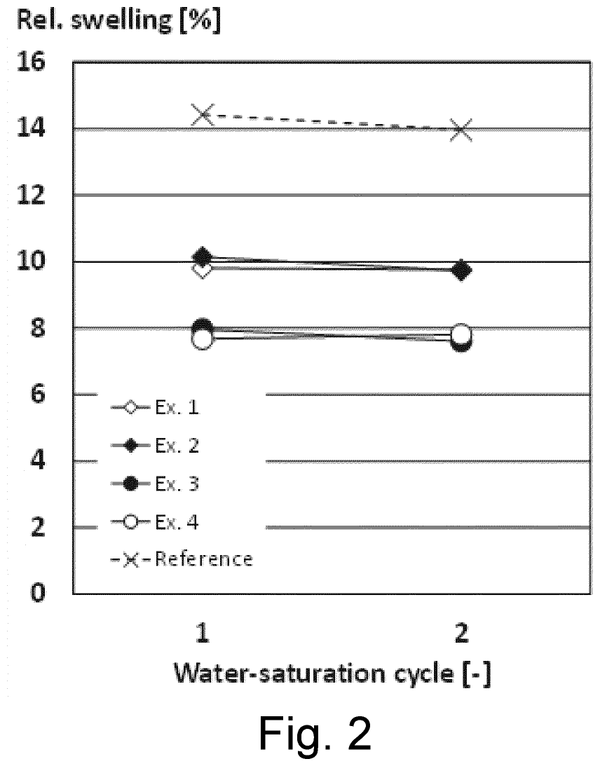

FIG. 2 is a diagram showing the relative swelling of the first to fourth example and a comparative example of the present invention,

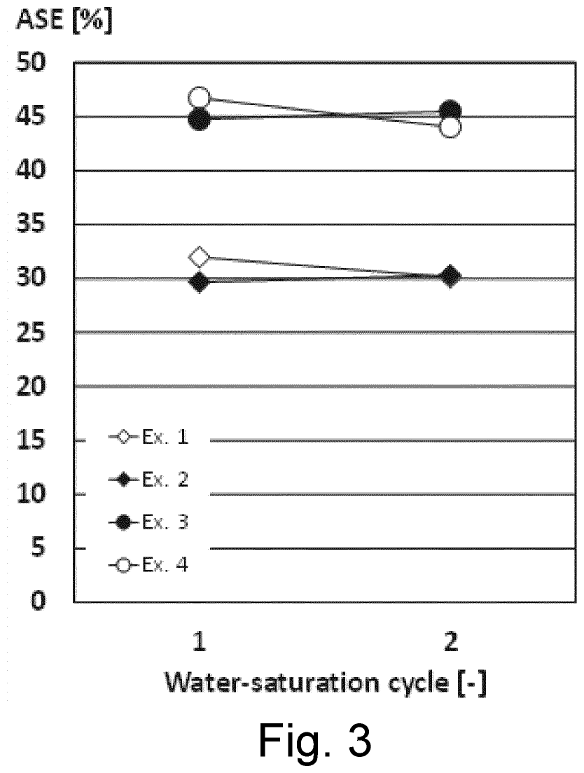

FIG. 3 is a diagram showing the Anti-Swelling Efficiency for the first to fourth example of the present invention,

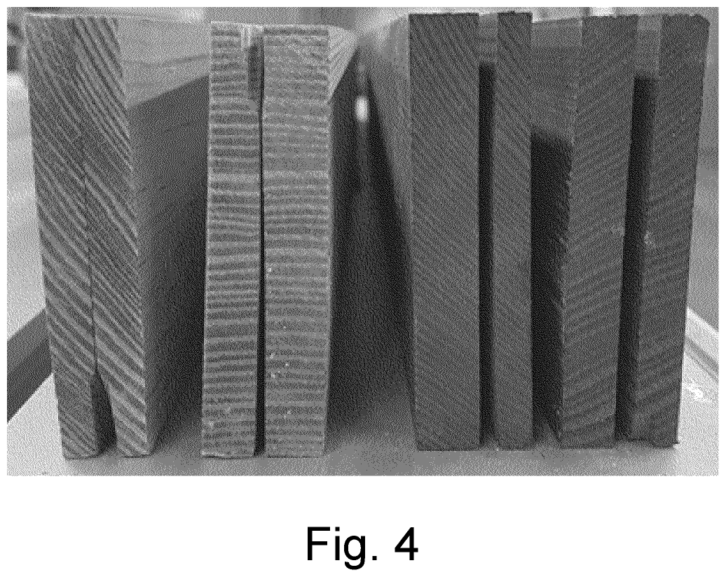

FIG. 4 is a photograph of the end grain surface of specimen according to the second comparative example and the fifth inventive example;

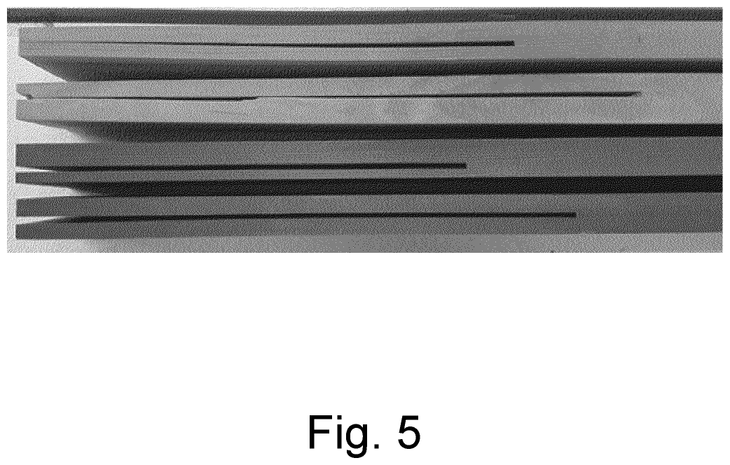

FIG. 5 is a photograph of an axially cut test specimen according to the second comparative example and the fifth inventive example;

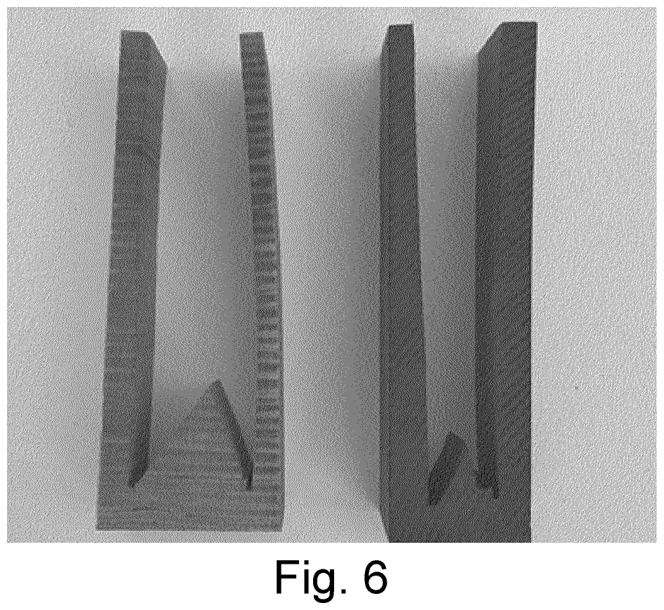

FIG. 6 is a photograph of two fork test specimen according to the second comparative example and the fifth inventive example;

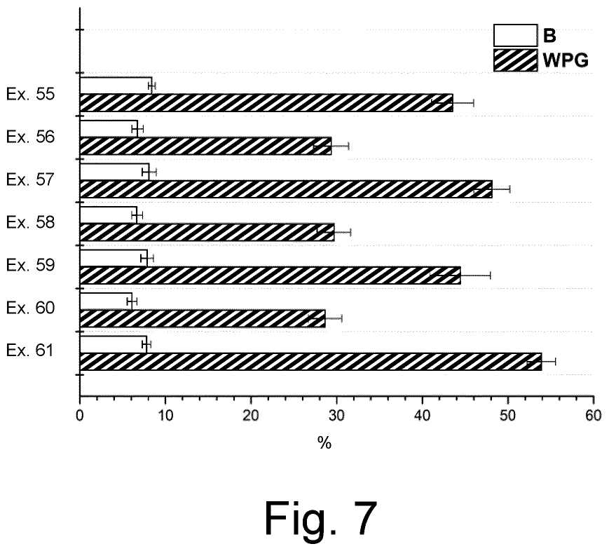

FIG. 7 is a diagram showing the cell wall bulking and weight percent gain of examples with different polyols; and

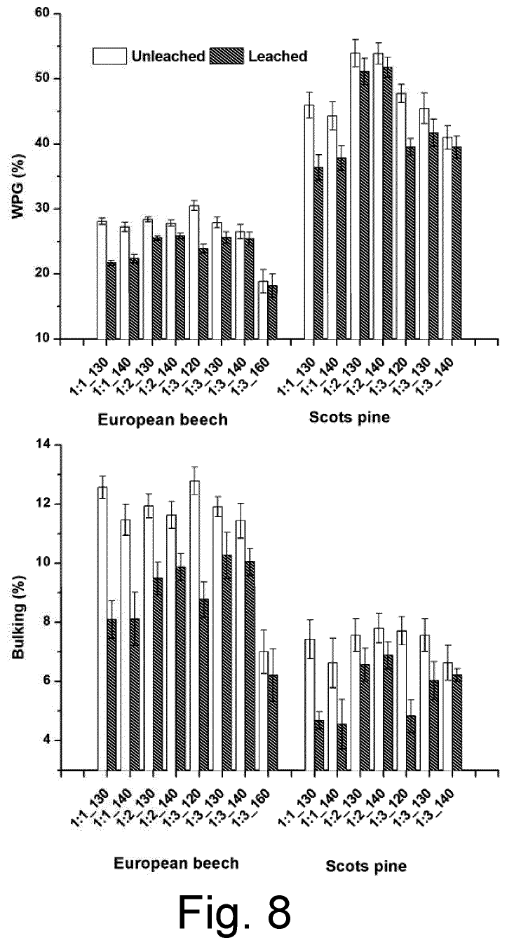

FIG. 8 is a diagram showing the weight percent gain and cell wall bulking before and after leaching of different wood types.

The invention will furthermore be described according to the following examples which are for illustrative purposes only and non-binding.

In the following four test specimen were provided according to the following procedure.

Scots pine sapwood specimens were fully impregnated with an aqueous solution of sorbitol and citric acid at molar ratios of 1:1 (Ex. 1 and 2) and 1:3 (Ex. 3 and 4).

In Example 1 and 3 an impregnation solution comprising 20 g of the combination of sorbitol and citric acid per 80 g water was used. In Example 2 and 4 an impregnation solution comprising 30 g of the combination of sorbitol and citric acid per 70 g water was used.

Wood specimens were impregnated with the respective impregnation solution in a vacuum-pressure impregnation process of 1 hr vacuum at 50 mbar followed by 2 hr overpressure at 12 bars. Fully impregnated specimens were dried and the modifying agents cured under superheated steam conditions at 140° C. For this, impregnated specimens were immediately after the impregnation (no pre-drying required) exposed to elevated temperature in a drying chamber with controlled air ventilation. Starting from ambient climatic conditions, the temperature was increased to ≥100° C. and the air inside the drying chamber exchanged by water vapor within a period of 10 hrs.

Afterwards a superheated steam atmosphere was created by heating ‘wet steam’ at temperatures≥100°. In a superheated steam atmosphere, the temperature was increased to 110° C. in steps of 0.1° C./hr. Afterwards, temperature was increased to 140° C. with 3° C./hr. The temperature remained at 140° C. for 24 hrs, before a cooling phase followed under superheated steam atmosphere until ca. 100° C., reducing the temperature in steps of 1° C./hr.

Further cooling happened from 100 to 50° C. with a rate of 2° C./hr at ca. 80% relative humidity. Finally, a conditioning phase followed at constant temperature of 50° C. and a relative humidity of 70% for 24 hrs.

As a comparative/reference example, an untreated sample was used.

FIGS. 1 to 3 show, respectively, the weight percentage gain, the relative swelling and the anti-swelling efficiency of the four inventive examples. As one can see, excellent properties can be obtained, especially when compared, as shown in FIG. 2., with an untreated sample.

FIG. 1 shows in detail the weight gain of the lignocellulose material according to examples 1 to 4, before (black) and after (striped) leaching for 14 days according to EN 84. Therefore, FIG. 1 shows the amount of reaction products of i) the organic compound having more than one hydroxy group and ii) the organic carboxylic acid having more than one carboxylic group, in the modified lignocellulose material.

FIG. 2 shows in detail the relative swelling of the lignocellulose material according to examples 1 to 4 and the reference (untreated sample), when being exposed to saturated water.

FIG. 3 shows in detail the anti-swelling efficiency (ASE) of the lignocellulose material according to examples 1 to 4.

Furthermore, a test specimen according to a fifth inventive example and a second comparative example was produced as follows:

According to the fifth inventive example, Scots pine sapwood (Pinus sylvestris L.) was impregnated according to inventive example 4. The impregnation process for inventive example 5 and comparative example 2 was identic to the one applied to the inventive examples 1— Impregnated specimens of the fifth inventive example had been dried in an superheated steam atmosphere according to inventive example 1-4. Impregnated specimens of the second comparative example had been dried under dry-conditions without steam. Like inventive examples 1-5, specimens of the second comparative example underwent the drying and curing immediately after the impregnation process.

According to the second comparative example, Scots pine sapwood (Pinus sylvestris L.) was impregnated with the same solution like it has been used for inventive example 4 and 5. Specimens of the second comparative example were dried at 103° C. for 8 hrs. Afterwards the temperature was increased to 110° C. within a period of ≤30 Min. Specimens were stored at constant temperature of 110° C. for 84 hrs. Finally, the temperature was increased to 140° C. within ≤60 Min. Specimens were stored at constant temperature of 140° C. for 24 hrs. Finally, the temperature was decreased to 50° C. and the specimens exposed to 50° C. for another 36 hrs.

FIGS. 4 and 6 show several photographs disclosing the differences between the comparative and the inventive example.

FIG. 4 shows the of specimen according to the second comparative example (the two specimens on the left) and the fifth inventive example (the two specimens on the right). At first it can be seen that the inventive examples have a brownish continuous coloring, whereas the comparative examples are much more lighter, but with irregular dark spots, which speaks for an uneven distribution of the impregnation material in the wood. This can also be observed in FIGS. 5 and 6.

FIG. 5 is a photograph an axially cut test specimen according to the second comparative example (upper two) and the fifth inventive example (lower two). When cutting the specimen (e.g. with a circular saw) for the comparative example a strong counter-force was observed, whereas the inventive examples could be cut smoothly and easily. This speaks for stronger strain and tensions in the comparative example than in the inventive one.

FIG. 6 is a photograph of two fork test specimen according to the second comparative example (left) and the fifth inventive example (right). The “fork test” shows a much stronger curvature of the comparative example, which again speaks for a much uneven distribution of the impregnation within the comparative example, as compared to the inventive one, and also for much greater strain and tension within the specimen according to the comparative example.

Table 1 shows further examples of the present invention that were carried out the same way as inventive examples 1 to 4, wherein various molar ratios of sorbitol and citric acid, various concentrations of these compounds in the impregnation solution, various curing temperatures and various curing times were used, as listed in the table.

The percentage weight gain of the sample (WPG) and the cell-wall bulking were measured before and after leaching the samples for 14 days according to EN 84. Additionally, the anti-swelling efficiency (ASE) was measured as before.

TABLE 1

| | Molar | | Curing | | Unleached | | Leached | | | | | | |
|---|---|---|---|---|---|---|---|---|---|---|---|---|---|
| | ratio | | temp. | Curing | WPG | CWB | WPG | CWB | ASE | | | | |
| Ex. | Sor:CA | wt % | [° C.] | time [h] | [%] | [%] | [%] | [%] | (1) | (2) | (3) | (4) | (5) |
| 6 | 1:1 | 30 | 110 | 24 | 50 | 7.1 | 28 | 3.4 | 16 | 21 | — | — | — |
| 7 | | | | 36 | 49 | 7.3 | 32 | 3.6 | 12 | 18 | — | — | — |
| 8 | 1:2 | | | 24 | 59 | 8.2 | 43 | 5.0 | — | — | — | — | — |
| 9 | 1:3 | | | 24 | 51 | 8.0 | 39 | 4.9 | 12 | 15 | — | — | — |
| 10 | | | | 36 | 50 | 7.5 | 40 | 5.1 | 15 | 16 | — | — | — |
| 11 | 1:1 | 30 | 120 | 24 | 48 | 7.9 | 32 | 4.0 | 13 | 18 | — | — | — |
| 12 | | | | 36 | 48 | 7.4 | 35 | 4.2 | 14 | 18 | — | — | — |
| 13 | 1:2 | | | 24 | 57 | 8.3 | 47 | 5.4 | — | — | — | — | — |
| 14 | 1:3 | | | 24 | 48 | 7.7 | 40 | 4.8 | 13 | 21 | — | — | — |
| 15 | | | | 36 | 47 | 7.9 | 40 | 5.8 | 16 | 20 | — | — | — |
| 16 | 1:1 | 30 | 130 | 24 | 46 | 7.4 | 36 | 4.7 | 20 | 24 | — | — | — |
| 17 | | | | 36 | 47 | 7.4 | 38 | 5.1 | 25 | 26 | — | — | — |
| 18 | 1:2 | | | 24 | 54 | 7.6 | 51 | 6.6 | 40 | 35 | 37 | — | — |
| 19 | 1:3 | | | 24 | 45 | 7.6 | 42 | 6.0 | 27 | 27 | — | — | — |
| 20 | | | | 36 | 46 | 7.9 | 43 | 6.4 | 27 | 26 | — | — | — |
| 21 | 1:0.5 | 30 | 140 | 24 | 41 | 5.4 | 18 | 2.2 | 21 | 23 | — | — | — |
| 22 | 1:1 | 20 | | | 27 | 5.2 | 22 | 3.5 | 33 | 31 | 32 | 28 | 27 |
| 23 | | 30 | | | 44 | 6.6 | 38 | 4.6 | 31 | 31 | 28 | 26 | 21 |
| 24 | 1:2 | | | | 54 | 7.8 | 52 | 6.9 | 45 | 45 | — | — | — |
| 25 | 1:3 | 20 | | | 26 | 5.1 | 25 | 4.6 | 45 | 46 | 43 | 43 | 38 |
| 26 | | 30 | | 12 | 43 | 6.7 | 38 | 4.9 | 26 | 28 | — | — | — |
| 27 | | | | 18 | 43 | 6.3 | 39 | 4.8 | 28 | 30 | — | — | — |
| 28 | | | | 24 | 41 | 6.6 | 40 | 6.2 | 49 | 45 | 44 | 43 | 39 |
| 29 | | | | 36 | 42 | 6.0 | 40 | 4.8 | 39 | 41 | — | — | — |
| 30 | | | | 48 | 39 | 5.7 | 37 | 4.5 | 37 | 40 | — | — | — |
| 31 | | 40 | | 24 | 55 | 7.2 | 52 | 6.0 | 31 | 35 | — | — | — |
| 32 | | 50 | | | 69 | 8.5 | 66 | 7.1 | 26 | 29 | — | — | — |
| 33 | | 60 | | | 84 | 9.5 | 80 | 8.1 | 17 | 15 | — | — | — |
| 34 | | 70 | | | 100 | 12.3 | 96 | 10.0 | 19 | 16 | — | — | — |

Table 2 shows further examples of the present invention that were carried out the same way as the previous example 4 (molar ratio Sor:CA=1:3 and 30 wt % total Sor/CA in the impregnation solution), wherein catalyst was added to the impregnation solution so that the impregnation composition comprises the catalyst in the given amount based on the total amount of impregnation composition.

TABLE 2

| | | | Curing | Unleached | | Leached | | |
|---|---|---|---|---|---|---|---|---|
| | | | temp. | WPG | CWB | WPG | CWB | ASE |
| Ex. | Catalyst | wt. % | [° C.] | [%] | [%] | [%] | [%] | (1) |
| 35 | SHP | 4 | 120 | 57 | 8 | 48 | 6 | — |
| 36 | (sodium | 6.5 | | 61 | 9 | 48 | 7 | — |
| 37 | hypophosphite) | 8 | | 67 | 8 | 49 | 6 | — |
| 38 | | 4 | 140 | 49 | 7 | 45 | 7 | — |
| 39 | | 6.5 | | 51 | 8 | 41 | 8 | — |
| 40 | | 8 | | 56 | 8 | 38 | 7 | 43 |
| 41 | MgCl₂ × 6H₂O | 2 | 120 | 51 | 8 | 14 | 4 | |
| 42 | | 3 | | 53 | 8 | 9 | 3 | |
| 43 | | 4 | | 52 | 8 | 49 | 2 | |
| 44 | | 2 | 140 | 41 | 6 | 30 | 7 | |
| 45 | | 3 | | 43 | 6 | 23 | 4 | |
| 46 | | 4 | | 56 | 8 | 38 | 3 | |
| 47 | HCl | 0.3 | 120 | 47 | 8 | 38 | 7 | — |
| 48 | | 0.6 | | 44 | 9 | 39 | 6 | — |
| 49 | | 0.9 | | 48 | 8 | 40 | 5 | — |
| 50 | | 0.3 | 140 | 44 | 8 | 42 | 7 | 47 |
| 51 | | 0.6 | | 43 | 7 | 41 | 6 | 51 |
| 52 | | 0.9 | | 43 | 8 | 41 | 7 | 48 |
| 53 | no catalyst | 0 | 120 | 48 | 8 | 40 | 5 | 13 |
| 54 | | 0 | 140 | 41 | 7 | 40 | 6 | 49 |

FIG. 7 is a diagram showing the cell wall bulking (B) and weight percent gain (WPG) in percent of examples with various polyols. The examples were prepared the same way as previous examples 1 to 4, wherein examples 55 to 58 were prepared using erythritol instead of sorbitol. Particularly, the examples were prepared according to the following table 3.

TABLE 3

| | organic compound having | | |
|---|---|---|---|
| | more than one hydroxy | Molar ratio | |
| Ex. | group used (polyol) | polyol:CA | wt % |
| 55 | erythritol | 1:3 | 30 |
| 56 | | 1:3 | 20 |
| 57 | | 1:2 | 30 |
| 58 | | 1:2 | 20 |
| 59 | sorbitol | 1:3 | 30 |
| 60 | | 1:3 | 20 |
| 61 | | 1:2 | 30 |

As can be seen from FIG. 7, similar results can be obtained from sorbitol and erythritol.

FIG. 8 is a diagram showing the weight percent gain (WPG) and cell wall bulking (Bulking) in percent, before and after leaching of samples from European beech and Scots pine. The examples were prepared the same way as previous examples 1 to 4, wherein different Sor:CA ratios (1:1 to 1:3) and different curing temperatures (120 to 160° C.) were used, as given in FIG. 8.

As can be seen from FIG. 8, different absolute values can be obtained for different wood types, wherein the trends between the examples remains comparable. Particularly, it can be seen from FIG. 8 that curing temperatures above 140° C. may be less favorable.

Furthermore, the following examples 62 and 63 were carried out, on 5 pinewood samples each (1.5×2.5×5 cm³ according to EN 113). The samples were held under a 10 mbar vacuum for 30 min. Afterwards the samples were submerged in impregnation composition for 1 hour at ambient pressure. After impregnation, the samples were held at 140° C. under superheated steam for 24 h, followed by leaching according to EN 84 and drying at 100° C. for 16 h.

In example 62, the impregnation solution comprised 20 wt. % sorbitol, 10.54 wt. % citric acid, 2 wt. % sulfuric acid as catalyst, and the rest water. In example 63, the impregnation solution did not comprise catalyst, i.e. the solution comprised 20 wt. % sorbitol, 10.54 wt. % citric acid, and the rest water.

Example 62 yielded in a weight loss of 9.9% from before leaching to after leaching, whereas example 63 had a weight loss of 45.4%, showing that the catalyst may lead to a better fixation of the impregnation solution.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The invention's scope is defined in the following claims and the equivalents thereto. Furthermore, reference signs used in the description and claims do not limit the scope of the invention as claimed.

1: A process for the preparation of a modified lignocellulose material is provided, comprising the steps of
a) impregnating the lignocellulose material with an aqueous impregnation composition comprising i) an organic compound having more than one hydroxy group and ii) a organic carboxylic acid having more than one carboxylic group;
b) treating the impregnated lignocellulose material at gat elevated temperature,
wherein step b) comprises the treatment of the impregnated lignocellulose material with superheated steam, where the superheated steam has a temperature of >100° C.

2: The process of claim 1, wherein the aqueous impregnation composition is nitrogen-free.

3: The process of claim 1, wherein the aqueous impregnation composition is for formaldehyde-free

4: The process of claim 1, wherein the organic compound having more than one hydroxy group comprises a carbohydrate and/or a sugar alcohol.

5: The process of claim 1, wherein the organic compound having more than one hydroxy group is selected from sorbitol, glucose, glycerol, dextrines, xylitol, saccharose, fructose, mannitol, erythritol, lactit, isomalt, maltitol, hydrated starch hydrolysate (HSH), threitole, adonitole, arabitole, galaktite and inosite or mixtures thereof.

6: The process of claim 1, wherein the organic carboxylic acid having more than one carboxylic group is selected from oxalic acid, malonic acid, succinic: acid, glutaric acid, adipinic acid, fumaric acid, citric acid, maleinic acid, isocitric acid, aconitic acid, malic acid, oxalosuccinic acid, trimesic acid trimellitie acid, hemimellitic acid, or mixtures thereof.

7: The process of claim 1, wherein the impregnation composition furthermore comprises a catalyst, preferably selected from sodium hypophosphite, magnesium chloride, sulfuric acid, and hydrochloric acid.

8: The process of claim 1, wherein the ratio of compound i) to compound ii) is mol/mol—or, if there is more than one compound i) and/or compound ii), the ratio of the sum of the compounds i) to the compounds ii)—is ≥1:10 to ≤2, preferred≥1:5 to ≤1.5 and most preferred≥1:3 to ≤1.

9: The process of claim 1, wherein the ratio of compound i) to compound ii) mol/mol—or, if there is more than one compound i) and/or compound ii), the ratio of the sum of the compounds i) to the compounds ii)—are chosen so that X is ≥0.05 to ≤1, preferred≥0.06 to ≤0.5 and most preferred≥0.1 to ≤0.4, whereby X is calculated as follows:
X=[X1/X2]/[X3/X4], with
X1=the molar amount of compound i)
X2=the number of hydroxy moieties in compound i)
X3=the molar amount of compound ii)
X4=the number of carboxylic acid moieties in compound ii)

10: The process of claim 1, wherein step b) occurs at a set temperature T_{A} which is kept essentially constant throughout the treatment.

11: The process of claim 1, wherein the set temperature T_{A} is 0° C. to =180° C.

12: The process of claim 1, wherein the set temperature T_{A} is >100° C., to ≤140° C.

13: The process of claim 1, wherein step b) comprises the steps b1) to b3):
b1) optionally heating the temperature up to ≥100° C. and generating a superheated stream atmosphere.
b2) Heating the temperature to the set temperature T_{A} with a heating rate, of 5° C. per hour
b3) Treating the impregnated lignocellulose material at the set temperature T_{A}

14: The process of claim 1, wherein step b) comprises the steps ba) to bc):
ba) Heating the temperature up to a temperature T_{B} lower than T_{A}, whereby the difference between T_{B} and T_{A} is ≥15° C. preferably ≥20 more preferred≥25° C. and most preferred≥30° C.
bb) Heating the temperature to the set temperature T_{A} with a heating rate of ≤5° C. per hour
bc) Treating the impregnated lignocellulose material at the set temperature T_{A}

15: The process of claim 1, further comprising a step c)
c) Cooling with a cooling rate of ≤10° C. per hour at a superheated stream atmosphere

16: Use of a process according to claim 1 for the modification of lignocellulose material.

17: A modified lignocellulose material obtained by the process of claim 1.
